(19) United States
(12) Patent Application Publication
(10) Pub. No.: US 2020/0089507 A1
(43) Pub. Date: Mar. 19, 2020

(54) LOW POWER EMBEDDED DEVICE USING A WRITE-ONCE REGISTER TO SPEED UP THE SECURE BOOT FROM SLEEP STATES OF THE DEVICE

(71) Applicant: SHENZHEN GOODIX TECHNOLOGY CO., LTD., SHENZHEN (CN)

(72) Inventors: MARTIN FROEHLICH, DRESDEN (DE); MATHIAS KURTH, DRESDEN (DE)

(21) Appl. No.: 16/693,198

(22) Filed: Nov. 22, 2019

Related U.S. Application Data
(63) Continuation of application No. PCT/CN2019/075728, filed on Feb. 21, 2019.

(30) Foreign Application Priority Data
Sep. 10, 2018 (EP) 18193411.8

(51) Int. Cl. G06F 9/4401; G06F 21/57; H04L 9/32; H04L 9/30

(52) U.S. Cl. CPC G06F 9/4401; H04L 9/30; H04L 9/3247; G06F 21/575

(57) ABSTRACT

The application discloses a low power embedded device, which uses a write-once register to speed up the secure boot from sleep states of said device. The object of the application to find a secure storage of the reference hash in low power embedded devices, which can be stored over sleep cycles of the device, and updates of the firmware of such devices are possible, and an unauthorized access to the storage must be prohibited will be solved by a low power embedded device comprising a special-purpose computing system, means for storing firmware of the device and a bootloader for verifying the integrity and authenticity of the firmware, whereas the bootloader checks a firmware hash of the firmware against a reference hash, wherein the reference hash is stored in a write-once register, which is part of an always on power domain of the embedded device.

### CROSS-REFERENCE TO RELATED APPLICATIONS

The present application is a continuation of International Application No. PCT/CN2019/075728, filed on Feb. 21, 2019, which claims priority to EP application number 18193411.8, filed on Sep. 10, 2018, entitled “low power embedded device using a write-once register to speed up the secure boot from sleep states of the device”. The disclosures of the aforementioned applications are incorporated by reference in their entireties.

### TECHNICAL FIELD

The application discloses a low power embedded device, which uses a write-once register to speed up the secure boot from sleep states of said device.

### BACKGROUND

Secure boot is an important feature for embedded systems. Secure boot is a security standard developed by members of the PC industry to help make sure that a device boots using only software that is trusted by the Original Equipment Manufacturer (OEM). When the PC starts, the firmware checks the signature of each piece of boot software, including Unified Extensible Firmware Interface (UEFI) firmware drivers (also known as Option ROMs), Extensible Firmware Interface (EFI) applications, and the operating system. If the signatures are valid, the PC boots, and the firmware gives control to the operating system. Hence, only authenticated (trusted) code is allowed to be executed on such systems.

This can be ensured by the bootloader, an immutable part of code. The bootloader stored in read only memory (ROM) is the root of trust. This code is always executed at the system startup. This code verifies the integrity and authenticity of the actual firmware (mostly stored in flash memory) prior to execution of this firmware.

The integrity of the firmware is verified by calculating a hash (e.g. sha256) over the firmware image and by comparing with a reference hash. To ensure the authenticity, the reference hash must be either stored in an immutable storage (like one-time programmable memory) during factory programming, or must be verified by a digital signature algorithm (DSA) at firmware startup.

Secure embedded systems with firmware update functionality are always using DSA to authenticate new firmware images.

A DSA public root key is stored as a part of the bootloader and the firmware image is signed with a corresponding private key.

Low power embedded devices with limited energy resources (like batteries) are usually most of the time in a power-off state to save energy and wake up on certain events.

To detect unauthorized changes of the firmware, the bootloader must check the firmware hash against the reference hash.

A calculation of the reference hash with secure DSAs is computational intensive and should be reduced on such systems as much as possible. Thus, it is desirable to find a secure storage of the reference hash in low power embedded devices. The requirements of such storage can be summarized as follows: The reference hash must be stored over sleep cycles of the device, updates of the firmware of such devices must be possible, and an unauthorized access to the storage must be prohibited.

### SUMMARY

The object of the application will be solved by a low power embedded device comprising a special-purpose computing system, means for storing firmware of the device and a bootloader for verifying the integrity and authenticity of the firmware, whereas the bootloader checks a firmware hash of the firmware against a reference hash, wherein the reference hash is stored in a write-once register, which is part of an always on power domain of the embedded device.

The write-once register is written by the bootloader and cannot be modified afterwards. The advantage of using a write-once register is to speed up the boot process after waking up the embedded device by skipping the calculation of the reference hash. Only the hash over the firmware must be calculated and can be compared with the stored reference hash. A firmware hash of the firmware image is understood as the checksum calculated of the present firmware that is stored. A reference hash is understood as the checksum of the original (not manipulated) firmware that is calculated by the firmware developer in a save environment. Thus, the power consumption of the boot process is reduced. It is also advantageous that only a very small hardware overhead is needed to store the reference hash inside the write-once register. No huge public private key hardware accelerator is required, because the reference calculation must be done only once. Thus, the system/microchip of the embedded device can be smaller and cheaper.

Low power embedded devices have extensive applications in consumer, commercial, automotive, industrial and healthcare markets. Generally, an embedded device's operating system will only run a single application which helps the device to do its job. Examples of embedded devices include dishwashers, banking ATM machines, routers, point of sale terminals (POS terminals) and cell phones.

In an embodiment of the inventive low power embedded device, the write-once register is locked automatically and protected against manipulation once after programming. Only the processor with the persistent bootloader can access the register. Non-manipulating the write-once register is the main advantage of the application.

In another embodiment of the inventive embedded device, the write-once register has a same size as the reference hash. For a secure hash algorithm, e.g. sha256 only 256 bits have to be stored in the write-once register. This has the advantage that only a few flip-flops must be powered inside the always on domain. This enables a minimal power consumption.

In a preferred embodiment of the inventive embedded device, only a power-on reset or a software reset can access the write-once register. These are the only two possibilities to rewrite the write-once register. Only these two events, the power-on reset or the software reset, can reset this register. After one of these events, the register is cleared, unlocked and ready for programming. After programming, the register is locked automatically and protected against manipulation.

At a power-on reset the persistent bootloader starts executing, locates a firmware image and verifies a reference hash of the firmware image with a stored digital signature algorithm public root key, whereas the verified reference hash is stored in the write-once register and then the bootloader calculates a firmware hash of the firmware image and compares it against the verified reference hash, whereas the bootloader executes the firmware if the hash values match otherwise an error state is indicated. The power-on reset procedure is one of two events that allow a rewriting of the write-once register. A power-on reset is the reset that occurs (first event) when the device is powered on. If a power-on reset is performed the embedded device is initial powered on, and the registers are not locked and can be programmed. Any failed signature verification or any failed hash comparison is an indication of a corrupted or manipulated firmware image and requires special handling by the bootloader.

At a software reset the persistent bootloader starts executing, locates a new firmware image and verifies a new reference hash of the new firmware image with a stored digital signature algorithm public root key, whereas the new verified reference hash is stored in the write-once register and then the bootloader calculates a firmware hash of the new firmware image and compares it against the new reference hash, whereas the bootloader executes the new firmware if the hash values match otherwise an error state is indicated. The software reset procedure is the second event that allows a rewriting of the write-once register. A software reset is a system reset (all states/registers are set to their initial value) that can be issued via software, e.g. by writing a special value to a register. If a software reset is performed the updated firmware is stored firstly, whereas the registers are not locked and can be programmed. Any failed signature verification or any failed hash comparison is an indication of a corrupted or manipulated firmware image and requires special handling by the bootloader.

If the inventive low power embedded device should be waked-up from a sleep period, it is very preferred that the persistent bootloader starts executing, loads a verified reference hash from the write-once register and then the bootloader calculates a firmware hash of the firmware image and compares it against the stored reference hash, whereas the bootloader executes the firmware if the hash values match otherwise an error state is indicated. As the write-once register is part of the always on power domain it is advantageous that the reference hash is stored over sleep cycles. It is not necessary to re-calculate the reference hash again and again. Thus, the system/microchip can be smaller and cheaper. Any failed hash comparison is an indication of a corrupted or manipulated firmware image and requires special handling by the bootloader.

The application will be explained in more detail using an exemplary embodiment.

### BRIEF DESCRIPTION OF THE DRAWINGS

The appended drawings show:

FIG. 1 Inventive embedded device using a write-once register; and

FIG. 2 Flow chart of procedures using the low power embedded device at a power-on reset, at a software reset and after a wakeup.

### LIST OF REFERENCE SIGNS

1 low power embedded device;
2 processor; system CPU;
3 write-once register;
4 bus structure;
5 reset module;
6 ROM bootloader; and
7 firmware memory.

### DETAILED DESCRIPTION OF THE EMBODIMENTS

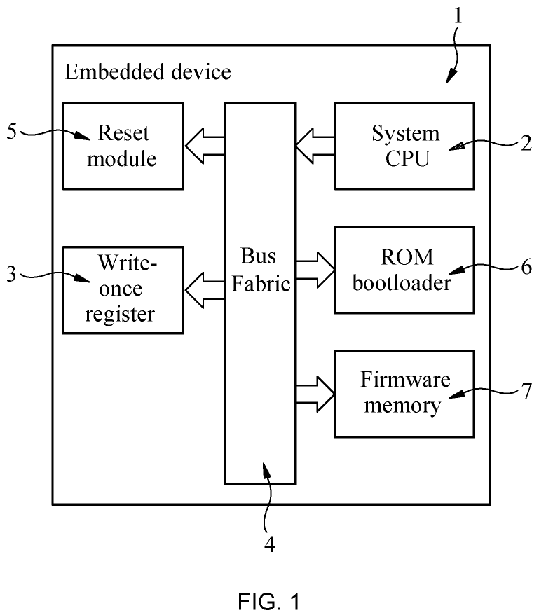

FIG. 1 shows a schematic drawing of the inventive embedded device 1 using a write-once register 3. The system CPU 2 has access over a bus fabric 4 to the components of the embedded device 1, such as a reset module 5, the ROM bootloader 6, the firmware memory 7 and the write-once register 3. The reset module 5 can perform a power-on reset, a software reset, especially a firmware reset.

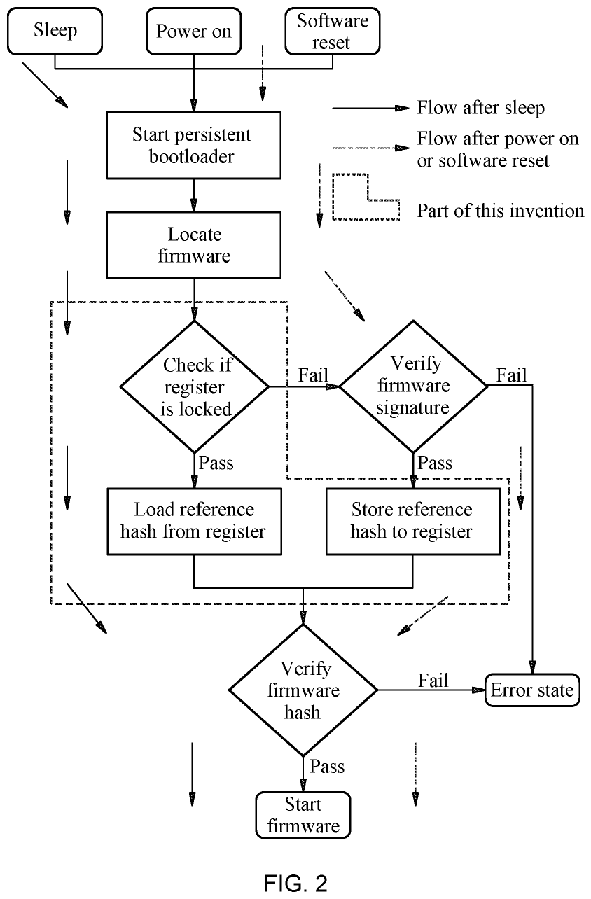

FIG. 2 shows an exemplary flow chart of different procedures performed with the low power embedded device 1 using a write-once register 3 for speeding up the secure boot process of said low power embedded device 1.

If the low power embedded device 1 is in a state to perform a power-on reset, the embedded device 1 is initial powered on, and the registers are not locked and can be programmed. Therefore, the persistent bootloader 6 starts executing. The bootloader 6 locates a firmware image of the embedded device 1 and verifies a reference hash of said firmware image with a stored digital signature algorithm public root key. The persistent bootloader 6 stores the verified reference hash in the write-once register 3, which is not locked and which can be programmed. Then the bootloader 6 calculates a firmware hash of the firmware image and compares it against the verified reference hash, whereas the bootloader 6 executes the firmware if the hash values match otherwise an error state is indicated. Any failed firmware signature verification is an indication of a corrupted or manipulated firmware image and requires special handling by the bootloader 6.

If the low power embedded device 1 is in a state to perform a firmware update the embedded device 1 is initial powered on, and the updated firmware image is stored. The new firmware replaces the existing firmware or is stored next to the existing firmware. This is done before the software reset is issued. The software reset triggers the ROM bootloader 6 to select the new firmware and to start the verification, because the software reset unlocks the write-once register. The persistent bootloader 6 starts executing. The bootloader 6 locates a new firmware image and verifies a new reference hash of the new firmware image with a stored digital signature algorithm public root key. The persistent bootloader 6 stores the new verified reference hash in the write-once register, which is not locked and which can be programmed. Then the bootloader 6 calculates a firmware hash of the new firmware image and compares it against the new reference hash, whereas the bootloader executes the new firmware if the hash values match otherwise an error state is indicated. Any failed signature verification or any failed hash comparison is an indication of a corrupted or manipulated firmware image and requires special handling by the bootloader 6.

If the low power embedded device 1 is in a state to perform a wakeup of the device after a longer sleeping period, the processor 2 wakes up but the reference hash register, hence the write-once register 3 is still locked. The persistent bootloader 6 starts executing. The bootloader 6 loads a verified reference hash from the write-once register 3 and then the bootloader 6 calculates a firmware hash of the firmware image and compares it against the stored reference hash. The bootloader 6 will execute the firmware only if the hash values match otherwise an error state will be indicated. As the write-once register 3 is part of the always on power domain it is advantageous that the reference hash is stored over sleep cycles. It is not necessary to re-calculate the reference hash again and again. Thus, the system/microchip can be smaller and cheaper. Any failed hash comparison is an indication of a corrupted or manipulated firmware image and requires special handling by the bootloader 6

What is claimed is:

1. An embedded device comprising a special-purpose computing system, means for storing firmware of the device and a bootloader for verifying the integrity and authenticity of the firmware, whereas the bootloader checks a firmware hash against a reference hash, wherein the reference hash is stored in a write-once register, which is part of an always on power domain of the embedded device.

2. The embedded device according to claim 1, wherein the write-once register is locked automatically and protected against manipulation once after programming.

3. The embedded device according to claim 1, wherein the write-once register has a same size as the reference hash.

4. The embedded device according to claim 1, wherein only a power-on reset or a software reset can access the write-once register.

5. The embedded device according to claim 4, wherein at a power-on reset the bootloader starts executing, locates a firmware image and verifies a reference hash of the firmware image with a stored digital signature algorithm public root key, whereas the verified reference hash is stored in the write-once register and then the bootloader calculates a firmware hash of the firmware image and compares it against the verified reference hash, whereas the bootloader executes the firmware if hash values match otherwise an error state is indicated.

6. The embedded device according to claim 4, wherein at a software reset the bootloader starts executing, locates a new firmware image and verifies a new reference hash of the new firmware image with a stored digital signature algorithm public root key, whereas the new verified reference hash is stored in the write-once register and then the bootloader calculates a firmware hash of the new firmware image and compares it against the new reference hash, whereas the bootloader executes new firmware if hash values match otherwise an error state is indicated.

7. The embedded device according to claim 1, wherein at a wakeup from sleep of the embedded device the bootloader starts executing, loads verified reference hash from the write-once register and then the bootloader calculates a firmware hash of the firmware image and compares it against the stored reference hash, whereas the bootloader executes the firmware if hash values match otherwise an error state is indicated.
